(19) United States
(12) Patent Application Publication
(10) Pub. No.: US 2026/0208229 A1
(43) Pub. Date: Jul. 23, 2026

(54) Optimized Sorting of Recycling Scrap

(71) Applicants: Boris Kurth, Kaarst (DE); Stefan Schlüter, Düsseldorf (DE); Benjamin Jaroni, Ratingen (DE)

(72) Inventors: Boris Kurth, Kaarst (DE); Stefan Schlüter, Düsseldorf (DE); Benjamin Jaroni, Ratingen (DE)

(73) Assignee: Speira GmbH, Grevenbroich (DE)

(21) Appl. No.: 19/398,567

(22) Filed: Nov. 24, 2025

Related U.S. Application Data
(63) Continuation of application No. PCT/EP2024/061062, filed on Apr. 23, 2024.

(30) Foreign Application Priority Data
Jun. 1, 2023 (DE) 10 2023 114 445.6

(51) Int. Cl. B07C 5/342; B03C 1/247

(52) U.S. Cl. CPC B07C 5/342; B03C 1/247; B03C 2201/20

(57) ABSTRACT

A method for sorting conveyed material, comprising the steps of providing conveyed material that includes components made of a metal or alloys thereof as well as other components. The method including separating components made of the metal or alloys thereof into a target fraction by means of at least one separating device. A residual fraction of non separated components remains. The method includes determining a loss portion of components made of the metal or alloys thereof in the residual fraction, and controlling or regulating the separating device depending on the determined loss portion. An apparatus for sorting and for carrying out the method is provided.

### CROSS-REFERENCE TO RELATED PATENT APPLICATIONS

This patent application is a continuation of International Application No. PCT/EP2024/061062, filed on Apr. 23, 2024, which claims the benefit of priority to German Patent Application No. 102023114445.6, filed Jun. 1, 2023, the entire teachings and disclosures of both applications are incorporated herein by reference thereto.

### FIELD OF THE INVENTION

The invention relates to a method for sorting conveyed material, comprising the steps: providing conveyed material comprising components made of a metal or alloys thereof as well as other components, and separating components of the conveyed material made of the metal or alloys thereof into a target fraction by means of at least one separating device, wherein a residual fraction of non-separated components of the conveyed material remains. The invention further relates to an apparatus for sorting, in particular for carrying out the method according to the invention.

### BACKGROUND OF THE INVENTION

Recycling scrap comprises, in addition to circulating and production scrap, in particular metal from used metal products which is collected, sorted and used for the preparation of other metal products. For example, scrap from used beverage cans, so-called Used Beverage Can (UBC) scrap, and similar products is collected, which can be recycled for use in further metal products such as new beverage cans.

Aluminum scrap, such as UBC scrap, is often a mixture of different aluminum alloys, for example of different alloys used for can bodies or can ends, and often contains foreign substances such as organic substances, e.g. wood, coatings and composite films, as well as other materials. One advantage of aluminum is that the metal can be remelted and reprocessed virtually any number of times. For the reprocessing of aluminum scrap, only about five percent of the energy required for the production of primary aluminum has to be expended.

In order to filter out and recover reusable materials such as non-ferrous metals, in particular aluminum and alloys thereof, from scrap, generic sorting methods and sorting apparatuses make use of the principle of eddy current separation. The scrap or conveyed material is guided, for example, on a conveyor belt or in free fall over the poles of a magnetic rotor. In the electrically conductive components of the conveyed material mixture to be separated, eddy currents are induced which build up their own magnetic fields directed opposite to the generating field and, by electromagnetic forces, accelerate these components, relative to the remaining components of the conveyed material mixture, substantially tangentially in the conveying or falling direction. These parts therefore in particular enter a flight trajectory much earlier than the non-conductive material parts, i.e. they lose contact with the conveyor belt or the magnetic rotor at a very early stage, for example. In this way, by means of eddy current separation, in particular non-ferromagnetic, electrically well-conductive materials such as aluminum and copper can be separated from non-ferrous metal solid mixtures such as UBC scrap, automobile shredder scrap, electronic scrap and the like. Eddy current separation may be preceded by magnetic separation in order to remove ferromagnetic parts in advance.

The acceleration of the metal parts, in particular the non-ferrous metal parts, is, however, frequently not sufficient to deflect the flight trajectory, which already begins at the apex of the magnetic rotor, sufficiently far beyond the radius of the magnetic rotor. Impairments caused by electrically non-conductive parts which are still lying on the belt surface or are only just detaching due to gravity cannot be ruled out either. For example, conductive parts to be deflected are decelerated by non-conductive parts. On the other hand, non-conductive parts can undesirably be accelerated due to carry-along effects caused by contact with conductive non-ferrous metal parts. As a consequence, incorrect entries in the sorting process cannot be avoided. In particular, relatively large proportions of metal parts, in particular non-ferrous metal parts, partially end up in the collecting region of the electrically non-conductive parts.

The sorting accuracy, in particular the metal loss, is therefore still not satisfactory. This disadvantage is all the greater the more the composition of the scrap material varies. As a consequence, valuable resources are regularly lost. In addition, metallic residues in connection with the combustion of the conveyed material sorted out as waste can be problematic. Increased proportions of metal can hinder the combustion. In particular, aluminum residues can, during combustion, also entail fire and explosion hazards, in particular hazards of oxyhydrogen explosions.

### SUMMARY OF THE INVENTION

The object of the present invention is therefore to provide a method for sorting conveyed material, by means of which the sorting accuracy can be increased in a process-reliable and cost-effective manner while at the same time the reject portion of components made of a metal and alloys thereof can be reduced. Moreover, the object of the present invention is to propose an advantageous apparatus for sorting conveyed material, in particular for carrying out a method according to the invention.

According to a first aspect of the present invention, the above-mentioned object is achieved, in the case of a method for sorting conveyed material, comprising the steps: providing conveyed material comprising components made of a metal or alloys thereof as well as other components, and separating components of the conveyed material made of the metal or alloys thereof into a target fraction by means of at least one separating device, wherein a residual fraction of non-separated components of the conveyed material remains, in that the method further comprises: determining a loss portion of components made of the metal or alloys thereof in the residual fraction, and controlling or regulating the separating device depending on the determined loss portion.

It has been found that, with the method according to the invention, the sorting accuracy during sorting of conveyed material can be increased. In particular, a higher yield can be achieved by the sorting than with known methods. By means of the method according to the invention, less recoverable metal, in particular non-ferrous metal, is lost, which would otherwise remain in the residual fraction and would not be used for further processing. For example, the separating, in particular the separating device, is adapted as soon as the loss portion increases and/or exceeds a certain threshold value. In particular, within the scope of the method, the loss portion in the residual fraction is determined continuously and used for controlling or regulating the separating device. With the method according to the invention, the sorting accuracy can be increased in a process-reliable and cost-effective manner, while at the same time the loss of components made of the metal and alloys thereof can be reduced.

The components made of a metal or alloys thereof are in particular metal pieces made of the metal or alloys thereof which are comprised by the conveyed material and are to be separated. It is conceivable that the components made of the metal or alloys thereof are only partially, but in particular completely or predominantly, composed of the metal or alloys thereof.

The metal may in particular be a non-ferrous metal, preferably aluminum. Accordingly, the components made of the metal or alloys thereof may in particular be non-ferrous metal pieces and/or alloy pieces, preferably aluminum pieces and/or aluminum alloy pieces. Thus, for example, the aim of the method is to separate as far as possible all components made of a metal, e.g. aluminum, and/or alloys thereof from the conveyed material in order to be able to reuse them. The method thus permits, by the improved sorting, a more sustainable production of aluminum products, for which the sorted aluminum and/or alloys thereof can be reused. In this way, the recycling proportion in aluminum products can be further optimized and valuable resources can be saved.

The method according to the invention permits an optimization of the sorting accuracy by determining the loss portion of components made of the metal or alloys thereof in the residual fraction and using it for controlling or regulating the separating device. Indications of portions generally quantify the proportion of an individual substance in a mixture. In the present context, this is also to be understood, for example, as portions which indicate the amount of a product with respect to a given volume or weight.

The other components may be partially or completely non-metallic components, for example components made of paper, cardboard, plastic and/or wood.

It is also conceivable that the other components comprise metallic components made of another metal or alloys thereof. Whether these components made of another metal or alloys thereof are assigned to the target fraction or the residual fraction during the separation depends on the separating device used. If the target fraction, in addition to the components made of the one metal and alloys thereof, comprises also other metallic components, the target fraction can, if necessary, be subjected to a further sorting with another separating device in order to further subdivide the target fraction and separate the components from one another. Thus, for example, it is conceivable that a conveyed material comprising aluminum alloy components and other components in the form of non-metallic components and iron alloy components is separated from the non-metallic components by the method described here and/or the apparatus described here, and that the further separation of the target fraction comprising aluminum alloy components and iron alloy components is carried out by a further sorting. Additionally or alternatively, a presorting can also be carried out in which, for example, ferromagnetic parts are removed from the conveyed material in advance.

By determining the loss portion, a statement can be made about the loss of metal components that are actually usable, in particular non-ferrous metal components such as, for example, aluminum. Depending thereon, it is possible, by means of the method according to the invention, to in turn influence the control or regulation of the separating device, whereby, for example, a reduction of the loss portion can advantageously be achieved. By the continuous monitoring of and the controlled influence on the separation, the sorting process can be optimized.

Regulating in this context means that the actual value of a parameter, in the event of a deviation from a desired target value, is changed by suitable process intervention in such a way that the actual value approaches the target value and, ideally, reaches it. A closed action sequence is thus present. Because the drifting away from the target value is counteracted, the feedback is negative feedback.

In contrast, in the case of control there is no feedback and consequently no closed action sequence. Control is understood to mean influencing of the behavior of a system, whereby the system is brought into another state by control.

The control or regulation can be carried out by influencing selected parameters, for example by reducing or increasing a value.

The control or regulation according to the invention is characterized in that it is carried out depending on the loss portion in the residual fraction and thus depending on the loss of metals that are actually usable. This has the advantage that it is also possible to react appropriately to scatterings or a varying composition in the scrap or conveyed material, and that the residual fraction can thus reliably be freed from the components made of the metal or alloys thereof.

The method according to the invention thus permits a higher yield of (re)usable metal components while avoiding losses in sorting accuracy. It therefore provides a resource-conserving, cost-effective solution for sorting conveyed material and additionally reduces hazards due to metallic residues which can be problematic in connection with the combustion of the conveyed material sorted out as waste.

It is also conceivable that the proportion of components made of the metal or alloys thereof in the target fraction is determined. In this way, it is possible to determine, for example, whether there are no impurities in the metal intended for further use. It is furthermore conceivable that the composition of the supplied conveyed material is detected, in particular that the proportion of components made of the metal or alloys thereof in the conveyed material is determined. For example, it is possible to determine the extent to which the composition of the supplied conveyed material influences the subsequent sorting accuracy. It is conceivable that, on the basis of empirical values, in particular machine learning, an influence is already exerted on the separation.

According to a first advantageous embodiment of the method according to the invention, the separating device comprises at least one conveyor belt, at least one magnetic rotor and/or at least one separating edge. The advantageous embodiment of the method according to the invention makes it possible in particular to influence the separating in many respects, to configure it particularly efficiently depending on possibly unforeseeable, different factors, such as the composition of the conveyed material, the size of the components of the conveyed material, etc., and to keep the sorting accuracy constant or even to increase it.

The conveyed material which comprises components made of the metal or alloys thereof is guided, for example, on a conveyor belt over at least one pole of a magnetic rotor. Due to the interaction with the at least one pole of the magnetic rotor, the components made of the metal or alloys thereof are accelerated, for example relative to the other components of the conveyed material, preferably tangentially to the conveying material direction. This takes place, for example, in that eddy currents are induced in the components made of the metal or alloys thereof, which build up their own magnetic fields that are directed opposite to the generating field, and these components are thus accelerated, by electromagnetic forces, relative to the other components of the conveyed material mixture substantially tangentially in the conveying direction. As a result, the components made of the metal or alloys thereof in particular enter a flight trajectory earlier and thus lose contact with the conveyor belt or the magnetic rotor earlier than other components of the conveyed material.

In the conveying direction, a discharge region, which may be formed, for example, by the magnetic rotor, thus adjoins a conveying region, which may be formed, for example, by the conveyor belt. Furthermore, at least two separating zones can adjoin, which are separated from one another by at least one separating edge which serves for separating the conveyed material. Preferably, the components made of the metal or alloys thereof, due to the acceleration, pass over the separating edge into the more distant separating zone, while other components of the conveyed material are not accelerated and instead only enter the forward separating zone, for example into a collecting region for the residual fraction. Depending on the loss portion in the residual fraction, the separating device is then controlled or regulated.

Depending on the loss portion of components made of the metal or alloys thereof in the residual fraction, the speed of the conveyor belt is controlled or regulated, for example. It has been found that it is thus possible, for example, to influence the flight trajectory and therefore the separating.

The at least one magnetic rotor and/or the at least one separating edge can also be controlled or regulated depending on the loss portion in the residual fraction.

According to an advantageous embodiment of the method according to the invention, the rotational speed and/or the magnetic field of the magnetic rotor is controlled or regulated depending on the loss portion. In this way, too, it is possible to influence the flight trajectory without the conveying speed having to be changed. The magnetic rotor comprises, for example, at least one electromagnet.

Preferably, the orientation and/or position of the at least one separating edge is controlled or regulated depending on the determined loss portion. By controlling or regulating the orientation, for example the inclination, and/or the position of the separating edge, an adaptation can be carried out in a particularly flexible, simple and cost-effective manner. Thus, for example, it is continuously possible to adapt the separating zones for separating the conveyed material. The separating can thereby also be optimized without changing the flight trajectory.

Preferably, the loss portion is determined by means of a detection device. The detection device can serve, for example, for the continuous determination of the loss portion. It is also conceivable that the loss portion is determined at regular intervals and/or as required. For example, depending on the loss portion determined by the detection device, the at least one conveyor belt, the at least one magnetic rotor and/or the at least one separating edge is controlled or regulated.

Particularly preferably, the detection device comprises a sensor and/or a camera. For example, a metal detector, e.g. an infrared sensor, for determining the loss portion is conceivable. The detection device detects, for example, the composition of the residual fraction and determines the loss portion.

According to a further advantageous embodiment of the method according to the invention, the controlling or regulating of the separating device depending on the loss portion in the residual fraction is carried out by means of a control device for controlling or regulating the separating device. The control device is in particular configured for controlling or regulating the separating device. The regulation can be carried out, for example, by a PID controller. The control can be carried out, for example, by means of a PLC control.

According to a second aspect of the present invention, the above-mentioned object is achieved by an apparatus for sorting conveyed material, in particular for carrying out the method according to the invention, comprising at least one separating device for separating components of a conveyed material made of a metal or alloys thereof into a target fraction, in that the apparatus further comprises: at least one detection device configured to determine a loss portion of components made of the metal or alloys thereof in a residual fraction of components of the conveyed material not separated by the separating device, and at least one control device configured to control or regulate the separating device depending on the loss portion.

The separating device of the apparatus is configured to separate components of a conveyed material made of a metal or alloys thereof into a target fraction. Accordingly, by means of the separating device, components of a conveyed material which comprises components made of a metal or alloys thereof as well as other components can be separated from the metal or alloys thereof and assigned to the target fraction.

The apparatus according to the invention has at least one detection device which is configured to determine a loss portion of components made of the metal or alloys thereof in a residual fraction of components of the conveyed material not separated by the separating device. The detection device may comprise, for example, a camera and/or a sensor. For example, an eddy current separator is adapted in such a way that, by means of a sensor and/or a camera, it can be checked how much metal or alloys thereof ends up on a waste conveyor belt. It is conceivable, for example, that the detection device comprises a camera and an evaluation unit, wherein the evaluation unit is configured to detect metallic components, for example on the basis of color, in images of the residual fraction captured by the camera and to determine, for example to estimate, their proportion in the residual fraction, for example as an absolute or relative value.

Based on the determined proportion of the metallic components in the residual fraction, the sorting can be adjusted. For this purpose, an actual value can, for example, be compared with a predetermined target value. For example, evaluation information can be transmitted to the control device of the apparatus. The control device can be configured to control or regulate the separating device, in particular the eddy current separator, depending on the evaluation information. On the basis of the evaluation information, the sorting can be set more efficiently. In this way, an aggregate can be operated which autonomously adjusts itself in accordance with the composition of the sorting material. As the control device for controlling or regulating the separating device depending on the loss portion, a PLC control or a PID controller can be provided, for example.

By means of the apparatus according to the invention for sorting conveyed material, the sorting accuracy during sorting of conveyed material can be increased. Thereby the apparatus according to the invention makes it possible to monitor the loss portion of components made of a metal or alloys thereof in the residual fraction and to influence the separating in a targeted manner, for example by controlling or regulating the separating device. In this way, the separating can be controlled or regulated such that a process-reliable, efficient and reliable sorting of the conveyed material is ensured. The reject of recoverable metal, in particular non-ferrous metal, can thereby be avoided. It has been recognized that, with the apparatus according to the invention, the sorting accuracy can be increased in a process-reliable and cost-effective manner, while at the same time the loss of metals, in particular non-ferrous metals such as, for example, aluminum, can be reduced. In the overall cycle, metal losses can thus be reduced and a reduced down-grading can be achieved by an almost equivalent use of materials.

According to an advantageous embodiment of the apparatus according to the invention, the separating device comprises at least one conveyor belt, at least one magnetic rotor and/or at least one separating edge. The advantageous embodiment of the apparatus according to the invention makes it possible in particular to influence the separating in many respects, to configure it particularly efficiently depending on possibly unforeseeable, different factors, such as the composition of the conveyed material, the size of the components of the conveyed material, etc., and to keep the sorting accuracy constant or even to increase it.

It is conceivable that the apparatus, alternatively or additionally to the detection device for detecting the loss portion, comprises a detection device which is configured to determine an excess portion of other components in the target fraction. The control device can additionally be configured to control or regulate the separating device depending on the determined excess portion. It is also conceivable that, alternatively or additionally, a control device is provided for controlling or regulating the separating device depending on the determined excess portion. By means of the apparatus, for example, the proportion of other components in the components made of a metal or alloys thereof in the target fraction can be determined and used for controlling or regulating the separating device in order to achieve a higher sorting accuracy. The method can comprise determining an excess portion of other components in the target fraction. The method can further comprise controlling or regulating the separating device depending on the determined excess portion.

The above-described features and embodiments of the invention may relate equally to the various aspects according to the present invention. The exemplary embodiments of the present invention described above in this description are also to be understood as being disclosed in all combinations with one another. It is to be understood, rather, that the presentation of embodiments of the invention is merely exemplary and not limiting.

There are now a multitude of possibilities for designing and further developing the method according to the invention as well as the apparatus according to the invention. In this regard, reference is made to the claims subordinate to claims 1 and 9, as well as to the description of exemplary embodiments in conjunction with the drawing. The figures are intended only for the purpose of illustration and not for defining the scope of protection of the invention. The figures are not to scale and are merely intended to exemplify the general concept of the present invention. In particular, features contained in the figures are by no means to be regarded as necessary components of the present invention.

### BRIEF DESCRIPTION OF THE DRAWINGS

The drawing shows in

FIG. 1 shows a schematic representation of an advantageous embodiment of an apparatus according to the invention according to the second aspect, and

FIGS. 2a, 2b shows a schematic representations of advantageous embodiments of the method according to the invention according to the first aspect.

### DETAILED DESCRIPTION

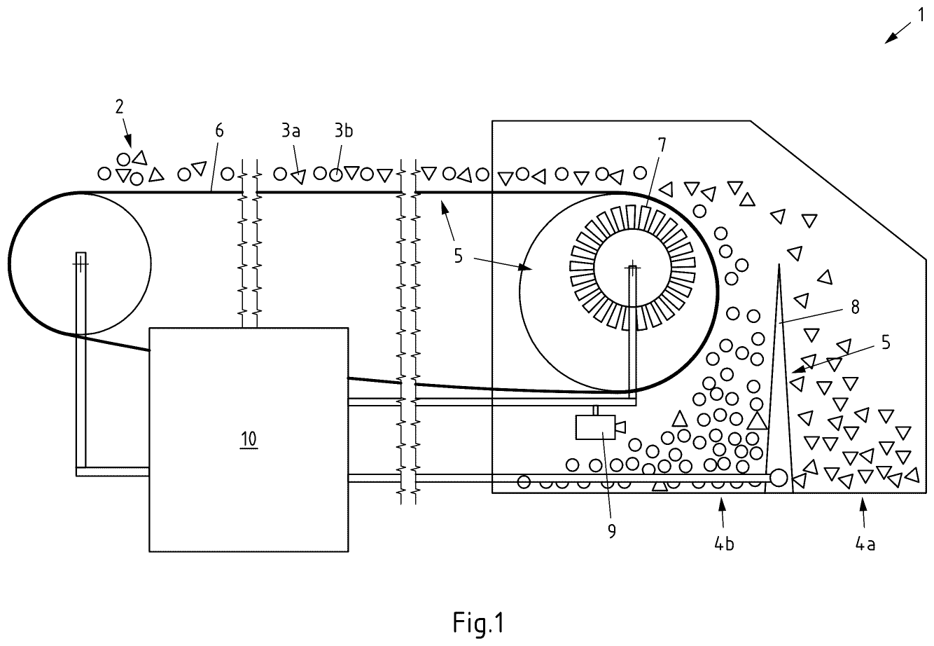

In FIG. 1, an apparatus 1 for sorting conveyed material 2 is illustrated. The conveyed material 2 is present in the form of a solids mixture. This can comprise different components 3a, 3b having different shapes and sizes. In addition to components 3a made of a metal or alloys thereof, the conveyed material 2 can contain other components 3b, for example PET bottles, plastics, household waste, cardboard, wood and/or CO₂ cartridges. The conveyed material 2 is transported in particular by a conveyor belt 6. The belt speed is, for example, 0.5 m to 3 m/second. The conveyed material is transported, for example, at a speed of 1000 kg/hour.

The apparatus 1 comprises at least one separating device 5 for separating components 3a made of the metal or alloys thereof into a target fraction 4a. The separating device 5 comprises, for example, the conveyor belt 6, at least one magnetic rotor 7 and/or at least one separating edge 8.

The conveyed material 2, which comprises the components 3a made of the metal or alloys thereof as well as the other components 3b, is guided, for example, on the conveyor belt 6 over the at least one pole of the magnetic rotor 7. Eddy currents are induced in the components 3a made of the metal or alloys thereof of the conveyed material 2 to be separated. Due to the interaction with the at least one pole of the magnetic rotor 7, the components 3a are accelerated, for example relative to the other components 3b of the conveyed material 2, preferably tangentially to the conveying material direction. As a result, the components 3a enter a flight trajectory earlier than the other conveyed material components 3b and thus lose contact with the conveyor belt 6 or the magnetic rotor 7 earlier than the other components 3b of the conveyed material 2.

In conveying direction, at least two separating zones can adjoin, which are separated from one another by the at least one separating edge 8, which serves for separating the conveyed material 2. Preferably, the components 3a made of the metal or alloys thereof, due to the acceleration, pass over the separating edge 8 into the more distant separating zone, while the other components 3b of the conveyed material 2 are not accelerated and instead enter only the forward separating zone, for example into a collecting region for the residual fraction 4b.

The apparatus 1 further comprises at least one detection device 9 for determining a loss portion of components 3a made of the metal or alloys thereof in a residual fraction 4b of non-separated components 3a, 3b. The detection device 9 is arranged, for example, in such a way that it determines and/or monitors the loss portion of components 3a made of the metal or alloys thereof in the residual fraction 4b which is conveyed on a waste conveyor belt (not shown here). Alternatively or additionally, the detection device 9 can be arranged directly at the beginning of the separating zone into which the residual fraction 4b passes and/or in the separating zone into which the target fraction 4a passes. The detection device 9 comprises, for example, a camera and/or a sensor, for example a metal detector. For example, the detection device 9 comprises a camera and an evaluation unit, the evaluation unit being configured to detect the components 3a made of the metal or alloys thereof, for example on the basis of color, in images of the residual fraction 4b captured by the camera and to determine their proportion in the residual fraction 4b.

The detection device 9 can serve, for example, for the continuous determination of the loss portion. It is also conceivable that the loss portion is determined at regular intervals and/or as required.

Depending on the determined loss portion, the separating device 5 is then controlled or regulated. For this purpose, the apparatus 1 comprises at least one control device 10 for controlling or regulating the separating device 5 depending on the loss portion.

For example, depending on the loss portion determined by the detection device 9, the at least one conveyor belt 6, the at least one magnetic rotor 7 and/or the at least one separating edge 8 is controlled or regulated. It is conceivable, for example, that the speed of the conveyor belt 6, the rotational speed and/or the magnetic field of the magnetic rotor 7 and/or the orientation and/or position of the separating edge 8 is controlled or regulated depending on the determined loss portion of components 3a made of the metal or alloys thereof in the residual fraction 4b.

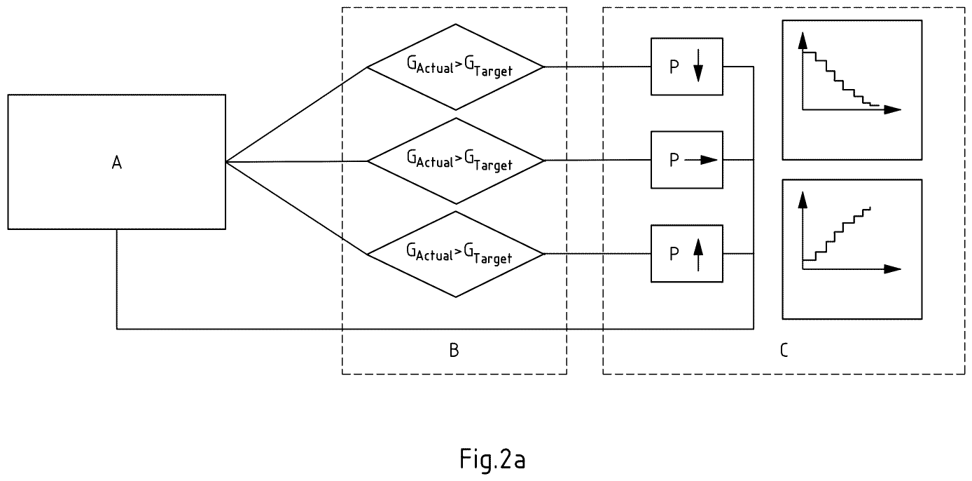

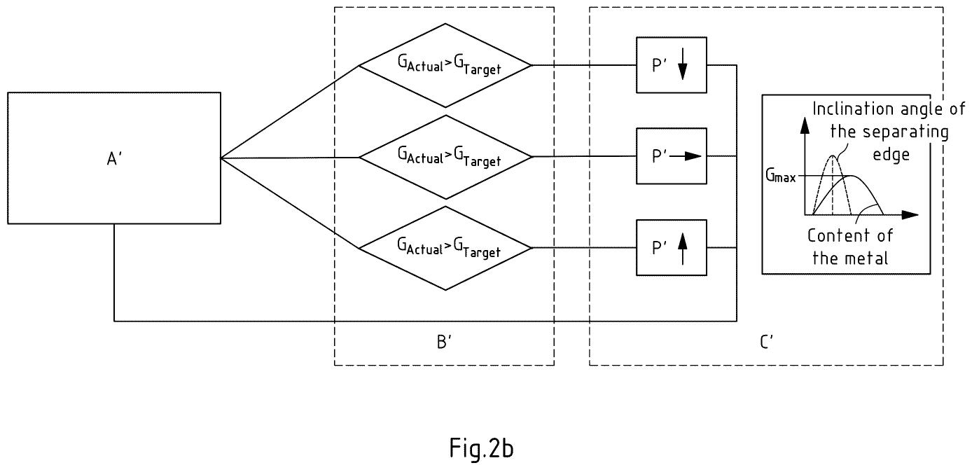

In FIG. 2a, an advantageous embodiment of the method according to the invention for sorting conveyed material 2 is shown. The method comprises providing conveyed material 2 comprising components 3a made of a metal or alloys thereof as well as other components 3b, separating components 3a of the conveyed material 2 made of the metal or alloys thereof into a target fraction 4a by means of at least one separating device 5, wherein a residual fraction 4b of non-separated components 3a, 3b of the conveyed material 2 remains, and determining a loss portion of components 3a made of the metal or alloys thereof in the residual fraction 4b.

In the present case, the separation is controlled depending on the determined loss portion of components 3a made of the metal or alloys thereof in the residual fraction 4b. During the separation in step A, the actual loss portion G_{Actual} of components 3a made of a metal or alloys thereof in a residual fraction 4b is determined and used in step C for process control of the separating, for example for controlling the separating device 5.

In step A, for example, the loss portion, in particular the non-ferrous metal portion, for example the aluminum portion, in the residual fraction 4b can be determined by means of a detection device 9, for example a camera and/or a sensor.

During the separation, in step B the actual value of the loss portion is used for process control of the separation. For this purpose, the actual value G_{Actual} is compared with a target value G_{Target}. Depending on the value of G_{Actual}, the separating device 5 is controlled. For example, in step C at least one manipulated variable P, e.g. the inclination angle of the separating edge 8, is decreased if the value of G_{Actual} is greater than the value of G_{Target}. If the value of G_{Actual} is smaller than the value of G_{Target}, the manipulated variable P is increased. This can also be carried out in the opposite way. If the value of G_{Actual} is equal to the value of G_{Target}, the manipulated variable remains unchanged.

In addition to the inclination angle of the separating edge 8, in the process control, for example, the position of the separating edge 8, the speed of the conveyor belt 6, the rotational speed and/or the magnetic field of the magnetic rotor 7 can also be controlled depending on the loss portion.

In FIG. 2b, a further advantageous embodiment of the method according to the invention is shown. In the present case, the separation, in particular the separating device 5, is regulated depending on the loss portion of components 3a made of the metal or alloys thereof in the residual fraction 4b. During the separation, in step A′ the actual loss portion G_{Actual} of components 3a made of the metal or alloys thereof in the residual fraction 4b is determined and used in step C′ for process regulation of the separation.

During the separation, the actual value G_{Actual} of the loss portion is used for process regulation of the separation. As in the case of process control, in step B′ the value of G_{Actual} is also compared with a target value G_{Target}. Depending on the value of G_{Actual}, in step C′ a manipulated variable P′, e.g. the inclination angle of the separating edge 8, is regulated. For example, the manipulated variable P′ is decreased if the value of G_{Actual} is greater than the value of G_{Target}. If the value of G_{Actual} is smaller than the value of G_{Target}, the manipulated variable P′ is, for example, increased. This can also be carried out in the opposite way. If the value of G_{Actual} is equal to the value of G_{Target}, the manipulated variable P′ remains unchanged.

In addition to the inclination angle of the separating edge 8, in the process regulation, for example, the position of the separating edge 8, the speed of the conveyor belt 6, the rotational speed and/or the magnetic field of the magnetic rotor 7 can also be regulated depending on the loss portion.

In contrast to control, in regulation there is a closed action sequence. The actual value G_{Actual} is compared several times, in particular continuously, with the target value G_{Target} and is influenced, in the sense of an adaptation to the target value G_{Target}, by changing the manipulated variable P′. For the process regulation, a PID controller can be used, for example.

In this way, losses of components 3a made of a metal or alloys thereof can be reduced or avoided and a high sorting accuracy can be achieved in a process-reliable and cost-effective manner.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Method for sorting conveyed material, comprising the steps:
providing conveyed material comprising components made of a metal or alloys thereof as well as other components, and
separating components of the conveyed material made of the metal or alloys thereof into a target fraction by means of at least one separating device, wherein a residual fraction of non-separated components of the conveyed material remains, wherein
the method further comprises:
determining a loss portion of components made of the metal or alloys thereof in the residual fraction, and
controlling or regulating the separating device depending on the determined loss portion.

2. Method according to claim 1, wherein
the separating device comprises at least one conveyor belt, at least one magnetic rotor, and/or at least one separating edge.

3. Method according to claim 2, wherein
the speed of the conveyor belt is controlled or regulated depending on the loss portion.

4. Method according to claim 2, wherein
the rotational speed and/or the magnetic field of the magnetic rotor is controlled or regulated depending on the loss portion.

5. Method according to claim 2, wherein
the orientation and/or position of the separating edge is controlled or regulated depending on the loss portion.

6. Method according to claim 1, wherein
the loss portion is determined by means of a detection device.

7. Method according to claim 6, wherein
the detection device comprises a sensor and/or a camera.

8. Method according to claim 1, wherein
the controlling or regulating of the separating device depending on the loss portion is carried out by means of a control device.

9. Apparatus for sorting conveyed material, in particular for carrying out a method according to claim 1, comprising:
at least one separating device configured to separate components of a conveyed material made of a metal or alloys thereof into a target fraction, wherein
the apparatus further comprises:
at least one detection device configured to determine a loss portion of components made of the metal or alloys thereof in a residual fraction of components of the conveyed material not separated by the separating device, and
at least one control device configured to control or regulate the separating device depending on the loss portion.

10. Apparatus according to claim 9, wherein
the separating device comprises at least one conveyor belt, at least one magnetic rotor, and/or at least one separating edge.
